(19) United States
(12) Patent Application Publication
(10) Pub. No.: US 2003/0191195 A1
(43) Pub. Date: Oct. 9, 2003

(54) Inversion of water-in-oil emulsions to oil-in-water emulsions

(76) Inventor: Ramesh Varadaraj, Flemington, NJ (US)

Correspondence Address: EXXONMOBIL RESEARCH AND ENGINEERING COMPANY, P.O. BOX 900, 1545 ROUTE 22 EAST, ANNANDALE, NJ, 08801-0900, US

(21) Appl. No.: 10/391,433

(22) Filed: Mar. 18, 2003

Related U.S. Application Data
(60) Provisional application No. 60/371,212, filed on Apr. 9, 2002.

(51) Int. Cl. B01F 3/08

(52) U.S. Cl. 516/925

(57) ABSTRACT

A method to invert a water-in-oil emulsion to an oil-in-water emulsion comprises contacting the water-in-oil emulsion with an aqueous colloidal dispersion including hydroxides of elements of Group II and Group III of The Periodic Table of Elements and mixtures thereof and then mixing the water-in-oil emulsion and aqueous colloidal dispersion until the water-in-oil emulsion inverts to an oil-in-water emulsion.

This is a Non-Provisional application of Provisional U.S. Serial No. 60/371,212 filed Apr. 9, 2002.

### FIELD OF THE INVENTION

The present invention relates broadly to the inversion of emulsions and the recovery of oils from emulsions.

### BACKGROUND OF THE INVENTION

Separation of water from crude oil is an important processing operation in production and refining of hydrocarbon oils. Occurrence of stable water-in-crude oil emulsions is detrimental to the separation process because these hard to demulsify emulsions form rag layers in the separator vessels. Rag layers comprising water-in-oil emulsions and sub-micron size solids form at the boundary between oil and water layers in separators. Rag layers result in oil loss and significantly reduce the efficiency and throughput of dewatering and desalting processes. Current methods using centrifuges, hydrocyclones and electrostatic demulsifiers require larger than desired doses of (>100 ppm) demulsifier chemicals, higher temperature and long residence times to desalt or dewater these water-in-oil emulsions. Thus, there is a continuing need for improved cost effective methods to demulsify water-in-oil emulsions. The present invention addresses this need.

### SUMMARY OF THE INVENTION

The invention includes a method for inversion of a water-in-oil emulsion to an oil-in-water emulsion comprising, contacting the water-in-oil emulsion with an aqueous colloidal dispersion comprising hydroxides of elements of Group II and Group III of The Periodic Table of Elements and mixtures thereof in a ratio range of 1:99 to 80:20 by weight of the water-in-oil emulsion to the weight of the aqueous colloidal dispersion, and then mixing the water-in-oil emulsion and aqueous colloidal dispersion until the water-in-oil emulsion inverts to an oil-in-water emulsion.

The invention also includes a method to recover oil from a water-in-oil emulsion comprising:

inverting the water-in-oil emulsion to an oil-in-water emulsion said inversion comprising, contacting the water-in-oil emulsion with an aqueous colloidal dispersion comprising hydroxides of elements of Group II and Group III of The Periodic Table of Elements and mixtures thereof in a ratio range of 1:99 to 80:20 by weight of the water-in-oil emulsion to the weight of the aqueous colloidal dispersion and mixing the water-in-oil emulsion and the aqueous colloidal dispersion until the water-in-oil emulsion inverts to an oil-in-water emulsion;

breaking the inverted oil-in-water emulsion; and

recovering the oil and water phases.

### DETAILED DESCRIPTION OF THE INVENTION

A method to invert a water-in-oil emulsion to an oil-in-water emulsion comprises contacting the water-in-oil emulsion with an effective amount of an aqueous colloidal dispersion of hydroxides of elements of Group II and Group III of The Periodic Table of Elements and then mixing the water-in-oil emulsion and aqueous colloidal dispersion until the water-in-oil emulsion inverts to an oil-in-water emulsion. The concentration of hydroxides of elements of Group II and Group III of The Periodic Table of Elements can be in the range of 0.001 to 5 wt % based on the weight of the aqueous phase. The preferred range is 0.001 to 1 wt %. The ratio of the water-in-oil emulsion to the aqueous colloidal dispersion can range from 1:99 to 80:20 by weight. The preferred ratio is 25:75 by weight.

Aqueous colloidal dispersions of hydroxides of elements of Group II and Group III of The Periodic Table of Elements are made by adding Group I hydroxides, for example sodium or potassium hydroxide to a solution of Group II and Group III chlorides, sulfates or carbonates. Group I hydroxide addition readily precipitates the Group II and Group III hydroxides. Calcium, magnesium, iron and aluminum hydroxides and mixtures of these hydroxides are the preferred Group II and Group III hydroxides. Calcium and magnesium hydroxides are more preferred. Sodium and potassium hydroxides are the preferred Group I hydroxides. A practical economic method to prepare an aqueous colloidal dispersion at a crude oil production facility is to add Group I hydroxides, for example sodium or potassium hydroxide to the produced brine wherein the produced brine contains soluble salts of Group II and Group III elements, for example calcium and magnesium. Required quantity of sodium hydroxide is added preferably in 5 to 20 aliquots with continuous mixing. Such an addition results in colloidal dispersions of the precipitated hydroxides. Alternately, commercially available calcium and magnesium hydroxides can be added to water and mixed used high shear mixing to provide the aqueous colloidal dispersion. The amount of hydroxides dispersed in the aqueous phase can vary in the range of 0.001 to 5 wt % based on the weight of water. A concentration of 0.001 to 1 wt % is preferred. The pH of the aqueous colloidal dispersion can be in the range of 6 to 12.

Aqueous colloidal dispersions of hydroxides of elements of Group II and Group III of the Periodic Table of elements can be stabilized by addition of colloid stabilizing additives selected from the group consisting of sodium lignosulfonate, ammonium lignosulfonate, potassium lignosulfonate, lignosulfonic acid and mixtures thereof in the range of 0.001 to 1 wt % based on the weight of water. The stabilizing additives can be added before or after precipitation of the hydroxides. It is preferred to precipitate the hydroxides first and then add the stabilizing additives and mix the solution.

The inversion of the water-in-oil emulsion to an oil-in-water emulsion can be detected by optical microscopy. In an oil-in-water emulsion oil droplets will be dispersed in a water continuous phase. In a water-in-oil emulsion water will be found dispersed in the oil phase. Other methods to detect inversion include conductivity and viscosity measurements. Conductivity corresponding to that of water is an indication that the emulsion is an oil-in-water emulsion. A viscosity between 1 and 5 cP is another indicator of an oil-in-water emulsion.

In the method to invert a water-in-oil emulsion to an oil-in-water emulsion, contacting times can vary from 0.1 hour to several days. Contacting is followed by mixing. Mixing can be in the shear rate range of 0.1 sec⁻¹ to 1000 sec⁻¹. Mixing is conducted using preferably static mixers, paddle mixers, or concentric rod and pipe mixers.

The inversion method disclosed is broadly applicable to any water-in-oil emulsion. It is particularly applicable to water-in-crude oil emulsions. The inversion method is suitable for crude oil emulsions that are solids-stabilized water-in-crude oil emulsions. Further, the solids stabilizing the water-in-crude oil emulsion can be silica, clay, crude oil asphaltenes, synthetic polymers or mixtures thereof. The water-in-crude oil emulsion may further comprise dissolved gas selected from the group consisting of methane, ethane, propane, butane, pentane, hexane, carbon-di-oxide and mixtures thereof. The water-in-crude oil emulsion can contain water in the range of 2 to 70 wt % based on the weight of the oil. The water droplets can be dispersed as droplets in the continuous crude oil phase in the size range of 0.1 to 200 microns. The water phase can further comprise dissolved salts comprising halides, sulfates and carbonate of Group I and Group II elements. Sodium chloride, calcium chloride and calcium bicarbonate are non-limiting examples of such salts.

The method of inverting the emulsion can be applied in a variety of environments. A few illustrative non-limiting examples include inversion in a container, e.g., a storage tank on a surface facility, crude oil production well bores, crude oil transportation pipelines, and subterranean reservoir environments

The invention also includes a method to separate oil from a water-in-oil emulsion comprising, inverting the water-in-oil emulsion to an oil-in-water emulsion including, contacting the water-in-oil emulsion with an aqueous colloidal dispersion including hydroxides of elements of Group II and Group III of The Periodic Table of Elements and mixtures thereof in a ratio range of 1:99 to 80:20 by weight of the water-in-oil emulsion to the weight of the aqueous colloidal dispersion, mixing the water-in-oil emulsion and aqueous colloidal dispersion until the water-in-oil emulsion inverts to an oil-in-water emulsion, breaking the inverted oil-in-water emulsion and then recovering the oil and water phases.

Breaking of the oil-in-water emulsion to its constituent oil and water components can be achieved by means such as gravity settling, centrifugation, hydrocyclone treatment and combinations thereof. The time and temperature for the breaking means can vary in the range of 0.1 to 48 hours at temperatures from 10° C. to 90° C. The breaking step involves the coalescence of oil droplets such that the small droplets of oil dispersed in the water continuous phase grow in size and eventually cream to the surface of water as an oil phase that can be drawn off or recovered from the container.

### EXAMPLES

The following non-limiting examples illustrate the invention.

### Example 1

Preparation of Aqueous Colloid Dispersion

Adding sodium hydroxide to synthetic Celtic brine whose composition is as follows made a colloidal dispersion of calcium and magnesium hydroxide:

| | |
|---|---|
| CaCl₂ 2H₂O | 2.48 g/L |
| MgCl₂ 6H₂O | 3.63 g/L |
| NaCl | 34.2 g/L |

The aqueous colloidal dispersion had about 0.6 g of calcium and magnesium hydroxides in 100 ml water.

### Example 2

Preparation of Solids-Stabilized Water-in-Crude Oil Emulsion

A solids-stabilized water-in-crude oil emulsion was prepared by adding to 40 g of oil, 60 ml of brine and mixing. Celtic crude oil diluted with n-decane 82:18 by weight was used as the oil. The oil was treated with 0.15 wt % oil wetted bentonite clay prior to brine addition.

### Example 3

Inversion of Water-in-Oil Emulsion to Oil-in-Water Emulsion by Aqueous Colloidal Dispersions of Group II and Group III Hydroxides and Separation of Oil from the Inverted Oil-in-Water Emulsion

To 10 g of the clay stabilized water-in-oil emulsion described in experiment 2 was added 5 ml of the aqueous colloidal dispersion described in experiment 1 and 10 ml of synthetic Celtic brine. The mixture was mixed using a Silverson mixer at 500 rpm for 10 minutes. The water-in-oil emulsion was observed to invert to an oil-in-water emulsion. Inversion was determined by observation under an optical microscope. Oil droplets in a continuous water phase were observed. The inverted emulsion had viscosity and conductivity corresponding to that of water, further confirming the water continuous oil-in-water emulsion. After inversion, the oil-in-water emulsion was broken by centrifuging the oil-in-water emulsion at 3000 rpm for 5 minutes. Oil separated out as a separate phase at the top of the centrifuge tube. The separated oil was pipetted out and weighed. 3.4 g of oil was recovered representing 85% efficiency for the process.

### Comparative Examples 4-8

| | | Inversion from |
|---|---|---|
| Example | Fluid | W/O to O/W |
| 4 | Celtic Brine | None |
| 5 | Celtic Brine + 1 wt % SLS | None |
| 6 | 1 wt % Aqueous HCl Solution | None |
| 7 | 1 wt % Sodium Hydroxide Solution | None |
| 8 | Celtic Brine + Sodium Hydroxide | Observed |
| | (Aqueous Colloidal Dispersion) | |

Example 4 is a comparative example using brine.

Example 5 is one where 1 wt % sodium lignosulfonate (SLS) is added to the brine solution.

Example 6 is the performance of an acid; hydrochloric acid added to distilled water.

Example 7 is the performance of a base; sodium hydroxide is added to distilled water.

Example 8 is an illustration of the invention and the uniqueness of the colloidal dispersion of hydroxides in causing the inversion.

All samples after contacting and mixing (as described in Example 3) were examined under an optical microscope. Only in the case of Example 8, a mixture of water-in-crude oil emulsion and oil-in-water emulsion was observed.

What is claimed is:

1. A method to invert a water-in-oil emulsion to an oil-in-water emulsion comprising:
(a) contacting the water-in-oil emulsion with an aqueous colloidal dispersion comprising hydroxides of elements of Group II and Group III of The Periodic Table of Elements and mixtures thereof in a ratio range of 1:99 to 80:20 by weight of the water-in-oil emulsion to the weight of the aqueous colloidal dispersion; and
(b) mixing the water-in-oil emulsion and aqueous colloidal dispersion until the water-in-oil emulsion inverts to an oil-in-water emulsion.

2. The method of claim 1 wherein said aqueous colloidal dispersion comprises about 0.001 to 5 wt % of hydroxides of elements of Group II and Group III of The Periodic Table of Elements and mixtures thereof and 95 to 99.999 wt % water.

3. The method of claim 1 wherein said aqueous colloidal dispersion has a pH in the range of 6 to 12.

4. The method of claim 1 wherein said aqueous colloidal dispersion further comprises 0.001 to 2 wt % of hydroxides of Group I elements of The Periodic Table of Elements.

5. The method of claim 1 wherein the aqueous colloidal dispersion further comprises colloid stabilizing additives selected from the group consisting of sodium lignosulfonate, ammonium lignosulfonate, potassium lignosulfonate, lignosulfonic acid and mixtures thereof in the range of 0.001 to 1 wt % based on the weight of water.

6. The method of claim 1 wherein said water-in-oil emulsion comprises 2 to 70 wt % water and 98 to 30 wt % oil.

7. The method of claim 1 wherein said water-in-oil emulsion further comprises 0.1 to 5 wt % solids selected from the group consisting of silica, clay, crude oil asphaltenes, synthetic polymers or mixtures thereof.

8. The method of claim 1 wherein said contacting is conducted for a time period of 0.1 hour to 120 hours at temperatures in the range of 10° C. to 90° C.

9. The method of claim 1 wherein the inversion is conducted in a container, production well bore, transportation pipeline, subterranean reservoir or combinations thereof.

10. A method to recover oil from a water-in-oil emulsion comprising:
(a) inverting the water-in-oil emulsion to an oil-in-water emulsion said inversion comprising, contacting the water-in-oil emulsion with an aqueous colloidal dispersion comprising hydroxides of elements of Group II and Group III of The Periodic Table of Elements and mixtures thereof in a ratio range of 1:99 to 80:20 by weight of the water-in-oil emulsion to the weight of the aqueous colloidal dispersion and mixing the water-in-oil emulsion and aqueous colloidal dispersion until the water-in-oil emulsion inverts to an oil-in-water emulsion;
(b) breaking the inverted oil-in-water emulsion; and
(c) recovering the oil and water phases.

11. The method of claim 10 wherein said breaking of the inverted oil-in-water emulsion comprises centrifugation, gravity settling, hydrocyclone treatment or combinations thereof.
